(19) United States
(12) Patent Application Publication
(10) Pub. No.: US 2024/0045158 A1
(43) Pub. Date: Feb. 8, 2024

(54) WAVEGUIDE SUBSTRATE CONNECTION SYSTEMS AND METHODS

(71) Applicant: CORNING RESEARCH & DEVELOPMENT CORPORATION, CORNING, NY (US)

(72) Inventors: Lars Martin Otfried Brusberg, Corning, NY (US); Robin May Force, Corning, NY (US); Sukru Ekin Kocabas, Santa Clara, CA (US); Shawn Michael O'Malley, Manchester, NH (US); Aramais Robert Zakharian, Painted Post, NY (US)

(21) Appl. No.: 18/379,134

(22) Filed: Oct. 11, 2023

Related U.S. Application Data
(63) Continuation of application No. PCT/US2022/023648, filed on Apr. 6, 2022.
(60) Provisional application No. 63/173,621, filed on Apr. 12, 2021.

(51) Int. Cl. G02B 6/42

(52) U.S. Cl. CPC G02B 6/4239; G02B 6/4228; G02B 6/4291

(57) ABSTRACT

Waveguide substrate connection systems and methods are provided herein. An example waveguide assembly comprises a first substrate having a first waveguide, a second substrate having a second waveguide, an adhesive, and one or more spacers. A height for the one or more spacers is less than 10 μm. The adhesive and the one or more spacers provide a composite material configured to assist in securing the first substrate and the second substrate together to align the first waveguide and the second waveguide. When the first substrate and the second substrate are attached together via the adhesive, the one or more spacers are configured to maintain a desired gap spacing therebetween so as to optimize coupling efficiency between the first waveguide and the second waveguide. The desired gap spacing corresponds to the height for the one or more spacers.

### PRIORITY APPLICATIONS

This application is a continuation of International Application Number PCT/US2022/023648 filed on Apr. 6, 2022, which claims the benefit of priority of U.S. Provisional Application No. 63/173,621, filed on Apr. 12, 2021. The content of each aforementioned application is relied upon and incorporated herein by reference in its entirety.

### FIELD

Embodiments of the present disclosure relate to waveguide assemblies, methods, and components and, more particularly, to connection systems and methods for effectively controlling gap spacing between two adhesively-connected waveguide substrates.

### BACKGROUND

Currently, evanescent coupling between two substrates including waveguides (e.g. ion-exchange waveguides in a glass substrate, laser-written waveguides in glass, silicon waveguides, silicon nitrate waveguides, etc.) is done by applying an adhesive between the two substrates and curing the substrates together to provide a permanent bond. It is desirable to obtain an optimal coupling distance between the substrates and waveguides during evanescent coupling to provide for efficient transfer between the waveguides of the two substrates. In evanescent coupling, the optimal coupling distance between the two waveguides in each substrate is a function of, for example, the waveguide properties (refractive index & geometry in glass), the glass (refractive index), the distance of overlap between the waveguides on each substrate, the alignment of each waveguide between substrates, the refractive index of the adhesive, tapered waveguide dimensions (e.g., width, length, refractive index) and the gap spacing between the two substrates.

Typically, when two substrates are bonded together, the gap spacing is difficult to control. Seemingly small inaccuracies in the order of 0.1 microns may have a relatively large impact on the evanescent coupling efficiency. Notably, the gap spacing between the two substrates is roughly dependent on the amount of adhesive, the viscosity of the adhesive, and the pressure applied to the substrates during bonding. This is often perceived as a major disadvantage for the evanescent coupling scheme, which otherwise is attractive in terms of vertical integration, low loss, relatively wide bandwidth, and polarization control. An approach for optimizing the evanescent coupling between two waveguides is therefore desired.

### SUMMARY

Various embodiments of the present disclosure relate to waveguide assemblies, methods, and components that may be used to effectively control the gap spacing between two substrates for evanescent coupling. An adhesive having spacers provided therein may be used to effectively control the gap spacing between two substrates. Where the two substrates comprise waveguides, effective control of the gap spacing between the two substrates may be critical so that evanescent coupling between the waveguides may be optimized. The spacers may be produced in a cost-efficient manner. Monodisperse spacers may be used so that the size of each spacer is substantially identical. Even where the spacers used are polydisperse, the size of the largest spacers may effectively control the resulting gap spacing when pressure is applied, and the resulting gap spacing provided using the spacers may be consistent in different waveguide assemblies. An advantage of using such example gap controlling adhesive and spacers is in being able to guarantee a degree of evanescent coupling between two waveguide containing substrates. Having a uniform power or optical coupling and lowest possible power loss from substrate-to-substrate is highly desirable.

As noted above, the gap spacing has historically been difficult to control. In particular, with the necessary gap spacing being so small, it has been difficult to consistently maintain the gap spacing within an acceptable range. Seemingly small inaccuracies in the order of 0.1 microns may have a relatively large impact on the evanescent coupling efficiency. The use of spacers may enable the effective control of the gap spacing, permitting optimal evanescent coupling to be reliably obtained. In some embodiments, the spacers may have a height of approximately 4 microns or less, but spacers may be used with different sizes as well. By using these spacers, a very small gap spacing may be effectively maintained between two substrates, providing for optimal evanescent coupling.

In this regard, in some example embodiments, an adhesive is provided that contains spacers with a defined geometry and a defined refractive index in order to evanescently couple the light between two substrates with waveguides. The spacers may be made of the same material as the adhesive such that the refractive index is not significantly distorted. This may be advantageous where spacers are used at locations proximate to waveguides. Notably, similar refractive index and/or material usage between the adhesive and spacers may, in some embodiments, not be necessary—such as when the spacers are used in dedicated contact areas between the substrates where the waveguides are not present.

In some example embodiments, the adhesive and the spacers may be combined together prior to application to the substrates. Alternatively, in some embodiments, the adhesive and the spacers may be applied at distinct times to the substrates.

In an example embodiment, a waveguide assembly is provided. The waveguide assembly comprises a first substrate having a first waveguide, a second substrate comprising a second waveguide, an adhesive, and one or more spacers. A height for the one or more spacers is less than 10 μm. The adhesive and the one or more spacers provide a composite material configured to assist in securing the first substrate and the second substrate together to align the first waveguide and the second waveguide. When the first substrate and the second substrate are attached together via the adhesive, the one or more spacers are configured to define a desired gap spacing between the first substrate and the second substrate so as to optimize coupling efficiency between the first waveguide and the second waveguide. The desired gap spacing corresponds to the height for the one or more spacers.

In this regard, in some embodiments, the height of the largest spacer may be in contact with the surface of both substrates so as to define the gap spacing.

In some embodiments for the waveguide assembly, the first substrate and the second substrate are provided so that they are parallel with each other. The first substrate comprises a first contact area and the second substrate comprises a second contact area. The first contact area of the first substrate and the second contact area of the second substrate are configured to receive and contact the adhesive and the one or more spacers. In some embodiments, the first contact area of the first substrate and the second contact area of the second substrate are flat and free of any recesses.

In some embodiments for the waveguide assembly, the first substrate and the second substrate are configured to receive the adhesive without any spacers at the first waveguide and the second waveguide respectively. However, in other embodiments, the first substrate and the second substrate are configured to receive the adhesive and spacers at the first waveguide and the second waveguide respectively.

In some embodiments for the waveguide assembly, each of the one or more spacers defines a spherical shape. The height for the one or more spacers may be less than 4 μm in some embodiments. In some embodiments, the height for the one or more spacers is between about 100 nm and about 4 μm. In some embodiments, the height for the one or more spacers is between about 300 nm and about 3 μm. In some embodiments, the height for the one or more spacers is between about 500 nm and about 2 μm.

In some embodiments for the waveguide assembly, the one or more spacers and the adhesive are separate from each other until positioned on the first substrate. In other embodiments, the one or more spacers and the adhesive are combined together to form combined adhesive and spacers before the combined adhesive and spacers are positioned on the first substrate.

In some embodiments for the waveguide assembly, the waveguide assembly may be formed by a process comprising placing the one or more spacers on the first substrate, pressing the second substrate onto the first substrate to form a gap therebetween, and then applying the adhesive proximate the gap to enable the adhesive to flow into the gap, such as via capillary force. In some embodiments for the waveguide assembly, the waveguide assembly may be formed by a process comprising placing the one or more spacers on the first substrate and then applying the adhesive onto the first substrate around the one or more spacers. In another embodiment, the waveguide assembly is formed by a process comprising inserting the one or more spacers into the adhesive to form combined adhesive and spacers, applying the combined adhesive and spacers onto the first substrate, and pressing the second substrate against the combined adhesive and spacers applied to the first substrate.

In some embodiments for the waveguide assembly, a refractive index of the adhesive is within 0.1 of a refractive index of the one or more spacers. The adhesive and the one or more spacers may comprise the same material in some cases.

In some embodiments for the waveguide assembly, the desired gap spacing is selected to optimize the amount of evanescent coupling between the first waveguide and the second waveguide. The desired gap spacing is determined based on one or more factors. These factors may include a material for the first substrate, a material for the second substrate, a material for the first waveguide of the first substrate, a material for the second waveguide of the second substrate, an overlap length between the first substrate and the second substrate, an overlap width between the first substrate and the second substrate, and an overlap area between the first substrate and the second substrate.

In another example embodiment, a composite material for use with waveguides is provided. The composite material comprises an adhesive and one or more spacers. The height for the one or more spacers is less than 10 μm. The adhesive and the one or more spacers provide a composite material configured to assist in securing a first substrate and a second substrate together. The one or more spacers are configured to maintain a desired gap spacing between two substrates so as to optimize coupling efficiency between the first waveguide and the second waveguide. The desired gap spacing corresponds to the height for the one or more spacers.

In some embodiments for the composite material, a refractive index of the adhesive is within 0.1 of a refractive index of the one or more spacers. In some cases, the adhesive and the one or more spacers may comprise the same material.

In some embodiments for the composite material, the composite material is made by placing the one or more spacers on a first substrate and by then inserting the adhesive on the first substrate between the one or more spacers. In other embodiments, the composite material is made by inserting the one or more spacers into the adhesive, wherein the composite material is formed before placing the one or more spacers on a first substrate.

In yet another example embodiment, a method for forming a waveguide assembly is provided. This method comprises providing a first substrate having a first waveguide, a second substrate having a second waveguide, an adhesive, and one or more spacers. The method also comprises placing the one or more spacers on a first contact area of the first substrate, with the height for the one or more spacers being less than 10 μm. The method further comprises placing the adhesive on the first contact area of the first substrate and pressing a second contact area of the second substrate into the first contact area of the first substrate until a desired gap spacing is obtained. The desired gap spacing is obtained so as to optimize coupling efficiency between the first waveguide and the second waveguide. The desired gap spacing corresponds to the height of the one or more spacers.

In some embodiments for the method, placing the one or more spacers on the first contact area of the first substrate occurs before placing the adhesive on the first contact area of the first substrate. In other embodiments, placing the one or more spacers on the first contact area of the first substrate occurs after placing the adhesive on the first contact area of the first substrate.

In yet another embodiment, a method for forming a waveguide assembly is provided. This method comprises providing a first substrate having a first waveguide, a second substrate having a second waveguide, an adhesive, and one or more spacers. This method further comprises inserting the one or more spacers into the adhesive to form a composite material, placing the composite material on a first contact area of the first substrate, and pressing a second contact area of the second substrate into the first contact area of the first substrate until a desired gap spacing is obtained. The desired gap spacing is obtained so as to optimize coupling efficiency between the first waveguide and the second waveguide. The desired gap spacing corresponds to the height of the one or more spacers. In some embodiments, the height for the one or more spacers is between about 100 nm and about 4 μm. In some embodiments, the height for the one or more spacers is between about 300 nm and about 3 μm. In some embodiments of the method, the height for the one or more spacers ranges from about 500 nm to about 2 μm.

In yet another embodiment, a waveguide assembly is provided. This waveguide assembly comprises a first substrate comprising a first waveguide, a second substrate comprising a second waveguide, and a composite material that is configured to assist in securing the first substrate and the second substrate together. The composite material comprises adhesive that includes one or more spacers mixed into an adhesive prior to application to the first substrate or second substrate. The one or more spacers are configured to maintain a desired gap spacing between the first substrate and the second substrate so as to optimize coupling efficiency between the first waveguide and the second waveguide. The desired gap spacing corresponds to the height of the one or more spacers.

Further areas of applicability of the present disclosure will become apparent from the detailed description provided hereinafter. It should be understood that the detailed description and specific examples, while indicating example preferred embodiments of the disclosure, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a top view illustrating an example first substrate with waveguides, in accordance with some embodiments discussed herein;

FIG. 2 is a cross-sectional schematic view illustrating a connection between a first substrate and a second substrate and an overlap portion that is formed, in accordance with some embodiments discussed herein;

FIG. 3 is a top schematic view illustrating alignment between the first substrate and the second substrate, in accordance with some embodiments discussed herein;

FIG. 4A is a graph illustrating the relationship between the evanescent coupling efficiency and the adhesive thickness when an overlap length of approximately one millimeter is used, in accordance with some embodiments discussed herein;

FIG. 4B is a graph illustrating the relationship between the evanescent coupling efficiency and the adhesive thickness when an overlap length of approximately 1.77 millimeters is used, in accordance with some embodiments discussed herein;

FIG. 4C is a graph illustrating the relationship between the coupling loss and the adhesive thickness, in accordance with some embodiments discussed herein;

FIG. 5 is a schematic view illustrating an example waveguide assembly, in accordance with some embodiments discussed herein;

FIG. 6A is a schematic view of a waveguide assembly where a second substrate is illustrated at a distance away from the first substrate, where the spacers are not positioned over the waveguides, in accordance with some embodiments discussed herein;

FIG. 6B is a schematic view of a waveguide assembly where a second substrate is illustrated at a distance away from the first substrate, where the spacers are positioned over the waveguides, in accordance with some embodiments discussed herein;

FIGS. 7A-D are flow charts illustrating example methods for forming a waveguide assembly, in accordance with some embodiments discussed herein; and

FIG. 8 shows an example optical printed circuit board (PCB), such as may be used with various example waveguide assemblies detailed herein.

### DETAILED DESCRIPTION

The following description of the embodiments of the present disclosure is merely exemplary in nature and is in no way intended to limit the invention, its application, or uses. The following description is provided herein solely by way of example for purposes of providing an enabling disclosure of the invention, but does not limit the scope or substance of the invention.

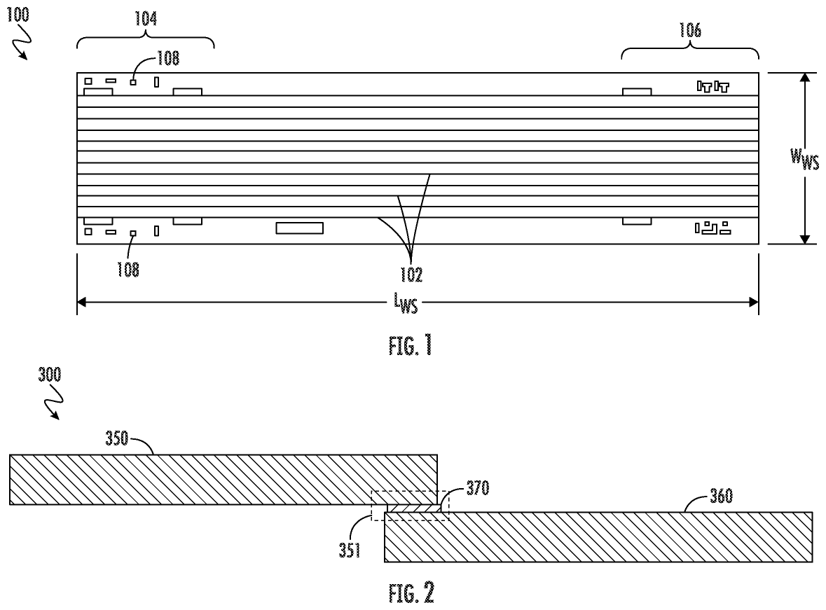

Substrates having one or more waveguides are frequently used in photonic applications and in other applications. FIGS. 1-3 illustrate various features of example substrates. FIG. 1 is a top schematic view illustrating an example first substrate 100, in accordance with some embodiments discussed herein. The first substrate 100 comprises a plurality of waveguides 102. In the illustrated embodiment, a planar ion-exchanged (IOX) waveguide is provided in a glass substrate. However, other types of waveguides (e.g., deposited glass waveguides, laser written waveguides, silicon waveguides, silicon nitrate waveguides, polymer waveguides) and other types of substrates may be used. Additional detail regarding waveguide coupling, including glass waveguide to silicon waveguide coupling, may be found in an article entitled “Glass Substrate with Integrated Waveguides for Surface Mount Photonic Packaging”, published in the Journal of Lightwave Technology and authored by Brusberg et al. This article is incorporated by reference herein in its entirety.

The first substrate 100 may comprise a first alignment region 104 and a second alignment region 106 (e.g., for alignment during connection to waveguides on another substrate). The first substrate 100 also may comprise one or more fiducials 108. The fiducials 108 may be used to align two or more substrates with each other. Fiducials 108 may be provided at the first alignment region 104 and/or at the second alignment region 106. The glass substrate may have a width (W_{WS}) of 3.8 mm and a length (L_{WS}) of 15 mm, but other sizes may also be employed.

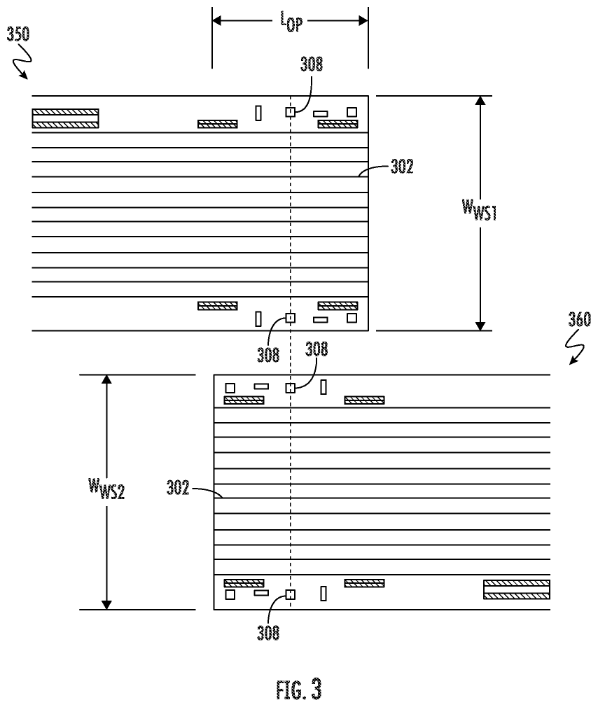

FIG. 2 is a schematic view illustrating a waveguide assembly 300 illustrating a connection between a first substrate 350 and a second substrate 360 and an overlap portion 351 that is formed, in accordance with some embodiments discussed herein. As shown, adhesive 370 may be provided in some or all of the area where the first substrate 350 and the second substrate 360 overlap. A polymer adhesive may be used in some embodiments, but other adhesives may be used as well. The type of adhesive that is used may be selected based on a variety of factors. These factors may include, for example, the refractive index of the adhesive, the cohesive strength, the adhesiveness to the particular material being used for the substrates, viscosity, reliability, cure conditions, etc. The refractive index of the adhesive is preferably selected so that it is conducive to evanescent coupling between waveguides in the two substrates being connected by the adhesive.

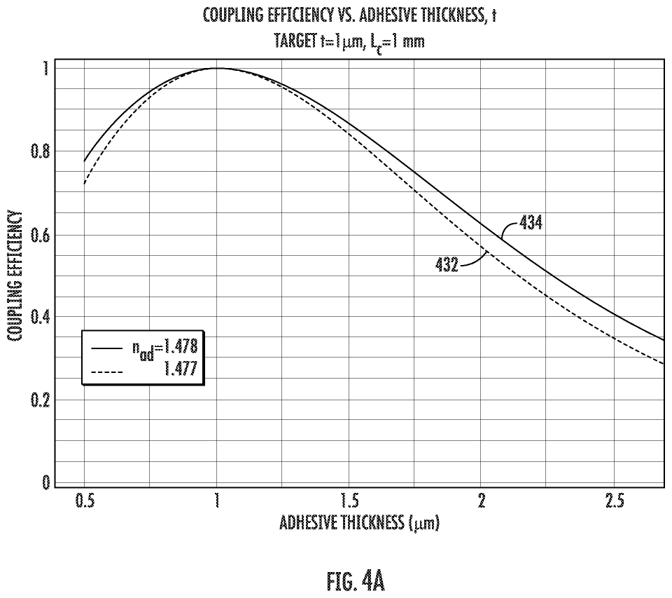

FIG. 3 is a top schematic view illustrating the alignment between the first substrate 350 and the second substrate 360, in accordance with some embodiments discussed herein. As shown, the first substrate 350 and the second substrate 360 may be aligned using fiducials 308 on the two substrates. In this example, the cross plane overhang is provided where the overlap length (L_{OP}) is 2.6 mm. In an example embodiment, where the overlap length is 2.6 mm and the glass substrate width (W_{WS1}, W_{WS2}) is 3.8 mm, the overlap area is 9.88 mm², and the amount of compressive force applied during bonding is approximately 5.2 N. In this illustration, the overlap length may be measured from the left end of the second substrate 360 to the right end of the first substrate 350. However, where the overlap length and the overlap area are changed (such as by selecting different fiducials to align based on similar shapes), the appropriate amount of compressive force may also be changed. For example, where an overlap length of 3.5 mm is used and where the glass substrate width (W_{WS1}, W_{WS2}) is 3.8 mm, the overlap area is 13.3 mm², and the appropriate amount of compressive force applied during bonding is 7 N.

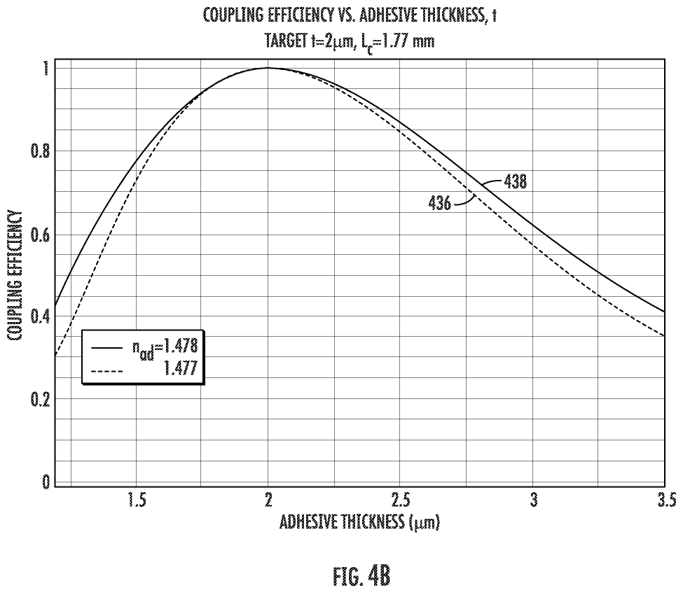

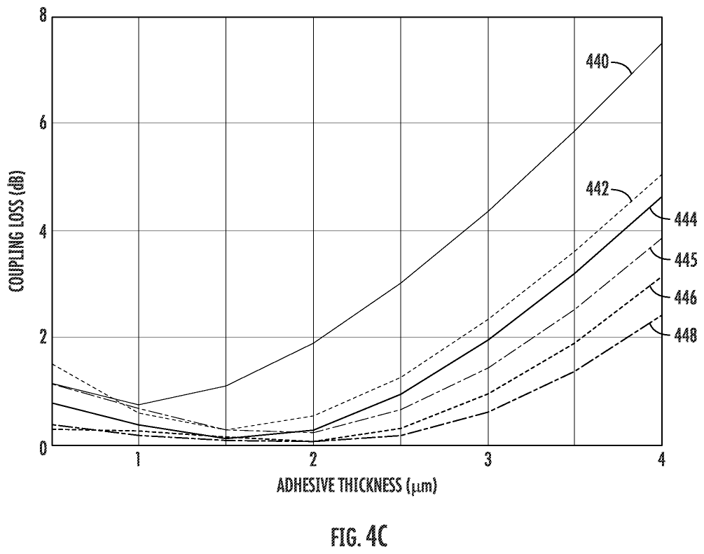

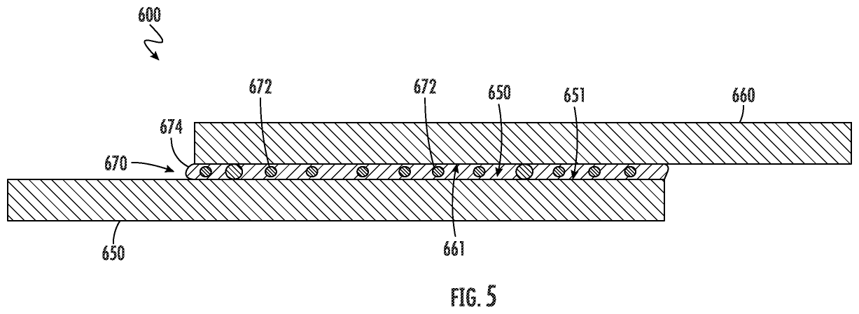

The evanescent coupling efficiency may be affected by a variety of factors, and one of those factors is the gap spacing between two substrates. The thickness of any adhesive used will frequently have a strong correlation with the resulting gap spacing. FIG. 4A is a graph illustrating the relationship between the evanescent coupling efficiency and the adhesive thickness when an overlap length of approximately one millimeter is used, in accordance with some embodiments discussed herein. This graph shows the theoretical coupling efficiency values occurring when a 1310 nm wavelength is being used. Two plot lines are provided. A first plot line 432 is provided for an adhesive having a refractive index (n_{ad}) of 1.477, and a second plot line 434 is provided for an adhesive having a refractive index (n_{ad}) of 1.478. For both the first plot line 432 and the second plot line 434, the optimal adhesive thickness is approximately 1 μm.

FIG. 4B is a graph illustrating the relationship between the evanescent coupling efficiency and the adhesive thickness when an overlap length of approximately 1.77 millimeters is used, in accordance with some embodiments discussed herein. This graph shows the theoretical coupling efficiency values occurring when a 1310 nm wavelength is being used. Two plot lines are provided. A first plot line 436 is provided for an adhesive having a refractive index (n_{ad}) of 1.477, and a second plot line 438 is provided for an adhesive having a refractive index (n_{ad}) of 1.478. For both the first plot line 436 and the second plot line 438, the optimal adhesive thickness is approximately 2 μm. As illustrated by FIGS. 4A and 4B, the overlap length may have a significant impact on the desired gap spacing required to optimize evanescent coupling between IOX waveguides (although the effects of overlap length on optimized evanescent coupling also apply to other types of waveguides and substrates). Further, as illustrated, even slight changes in the refractive index may have a significant impact on the coupling efficiency.

Just as the evanescent coupling efficiency may be affected by the adhesive thickness, the coupling loss may also be affected by the adhesive thickness. FIG. 4C is a graph illustrating the relationship between the coupling loss and the adhesive thickness, in accordance with some embodiments discussed herein. In this graph, six different plot lines are provided. For these plot lines, either a transverse electric (TE) mode or a transverse magnetic (TM) mode is used. A first plot line 440 illustrates the coupling loss as a function of adhesive thickness where a taper length of 1000 μm is used for the waveguides and where a TM mode is used. A second plot line 442 illustrates the coupling loss as a function of adhesive thickness where a taper length of 1500 μm is used and where a TM mode is used. A third plot line 444 illustrates the coupling loss as a function of adhesive thickness where a taper length of 1000 μm is used for the waveguides and where a TE mode is used. A fourth plot line 445 illustrates the coupling loss as a function of adhesive thickness where a taper length of 2000 μm is used for the waveguides and where a TM mode is used. A fifth plot line 446 illustrates the coupling loss as a function of adhesive thickness where a taper length of 1500 μm is used for the waveguides and where a TE mode is used. A sixth plot line 448 illustrates the coupling loss as a function of adhesive thickness where a taper length of 2000 μm is used for the waveguides and where a TE mode is used.

FIG. 4C shows the significant impact that the adhesive thickness may have on the coupling loss. With the necessary gap spacing being so small, it has historically been difficult to consistently maintain the gap spacing within an acceptable range. The sensitivity of the coupling loss to the separation between the waveguides, and hence to the adhesive thickness, leads to sub-micron tolerances on the waveguide separation. Seemingly small inaccuracies in the order of 0.1 microns may have a relatively large impact on the evanescent coupling efficiency. Thus, where an evanescent coupling scheme is employed, it is vital to consistently provide the waveguide separation within the specified tolerances. The embodiments described herein may allow for these tolerances to be routinely accomplished, and the embodiments may be configured so that they may be produced in a cost-efficient manner. Accordingly, some embodiments of the present disclosure employ the use of spacers to enable effective control of the gap spacing, permitting optimal evanescent coupling to be reliably obtained. In this regard, the height of the spacers may dictate the gap spacing, ensuring a desired gap spacing when the two substrates are brought together. This is a benefit over past processes that included bonding placement and application of a controlled amount of adhesive.

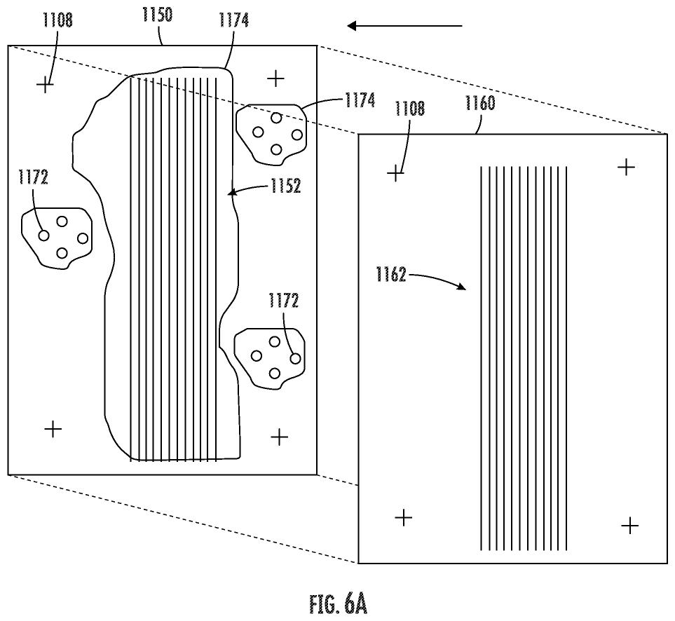

FIG. 5 is a schematic view illustrating a waveguide assembly 600, in accordance with some embodiments discussed herein. In this embodiment, a first substrate 650 and a second substrate 660 are provided, and these two substrates are provided parallel with each other. The two substrates may overlap, as illustrated previously in FIGS. 2 and 3. When the two substrates overlap, a gap 670 may be formed between the first substrate 650 and the second substrate 660. According to some example embodiments of the present disclosure, adhesive 674 and one or more spacers 672 may be provided within the gap 670 so as to help form a desired gap spacing. In this regard, one or more of the spacers may define a height extending between a first attachment surface 651 of the first substrate 650 and a second attachment surface 661 of the second substrate 660, where the height of the one or more spacers forms the desired gap spacing—preventing the substrates from coming closer in contact. Further, positioning of such spacers enables appropriate pressure to be applied to cause the substrates to come together to touch each side of such spacers—thereby forming the desired gap spacing. When the adhesive 674 and the one or more spacers 672 are provided together, this may form a composite material.

In an example embodiment, the spacers have a refractive index that is equivalent to the refractive index of the adhesive used. For example, the spacers have a refractive index that is within 0.1 of a refractive index of the adhesive. In some embodiments, the adhesive and the spacers may comprise the same material. Notably, however, in some embodiments, the spacers may have a refractive index that is smaller or greater than 0.1 of the refractive index of the adhesive used. In some such examples, the spacers may not contact the waveguides.

The spacers may be provided having any height that is designed to produce a desired gap spacing, and the spacers may be added to the adhesive to form the composite material. Notably, as described herein, some embodiments of the present disclosure contemplate that the spacers have a height of 10 microns or less (and, preferably, 4 microns or less) so as to correspond to the minimal gap spacing desired for the anticipated evanescent coupling for the waveguide assembly. In some embodiments various ranges of heights of the spacers are contemplated (e.g., between 500 nanometer and 2 microns, between 100 nanometers and 4 microns, between 300 nanometers and 3 microns, etc.). In some embodiments, the composite material may be formed before placing any spacers and/or adhesive on a substrate. In other embodiments, the composite material may first be formed when the spacers and the adhesive have both been added onto a substrate.

When the composite material is provided between two substrates, the spacers may be configured to maintain a desired gap spacing between the first substrate and the second substrate so as to optimize evanescent coupling between the first waveguide and the second waveguide. The height of the one or more spacers may correspond to the desired gap spacing. In some embodiments, the gap spacing may be equal to the height of the largest spacer within a group of one or more spacers.

The height of the spacers may be determined by placing the spacers between two opposing surfaces and then measuring the distance between the two surfaces. Where spacers are used that are spherical, the height may be equal to the diameter of the spherical spacers.

Various factors may affect the evanescent coupling efficiency. For example, these factors may include the material for the first substrate, the material for the second substrate, the material for the first waveguide of the first substrate, the material for the second waveguide of the second substrate, the overlap length between the first substrate and the second substrate as shown in FIGS. 4A-4C, the overlap width between the first substrate and the second substrate, and the overlap area between the first substrate and the second substrate. In selecting appropriate materials, the refractive index of the materials used may be an important factor. These factors may be considered alongside the desired gap spacing to enable optimal coupling efficiency.

Example spacers usable for various embodiments of the present disclosure include polymethylmethacrylate (PMMA) spacers, which are offered in sizes that are desirable for obtaining optimal coupling. PMMA spacers would have a similar refractive index to the adhesive that may be used for waveguide substrates. PMMA spacers are commercially available. Spacers may comprise other materials as well. For example, the spacers may comprise glass, silica, or another polymer.

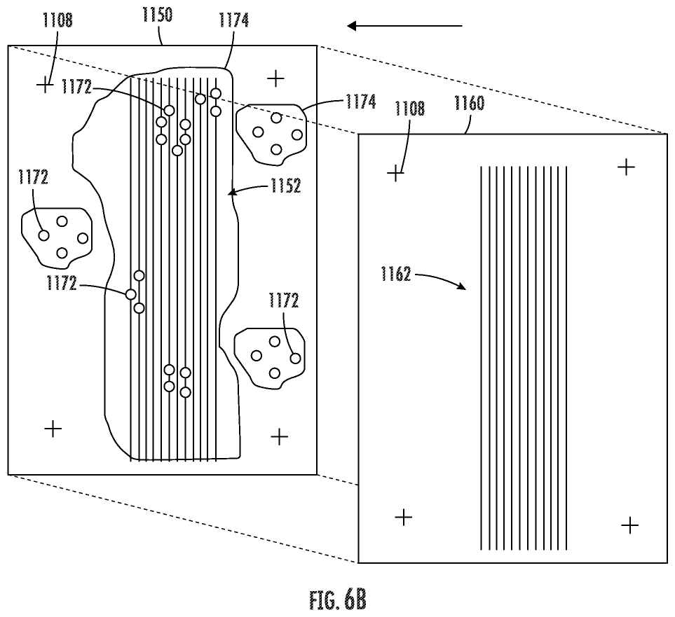

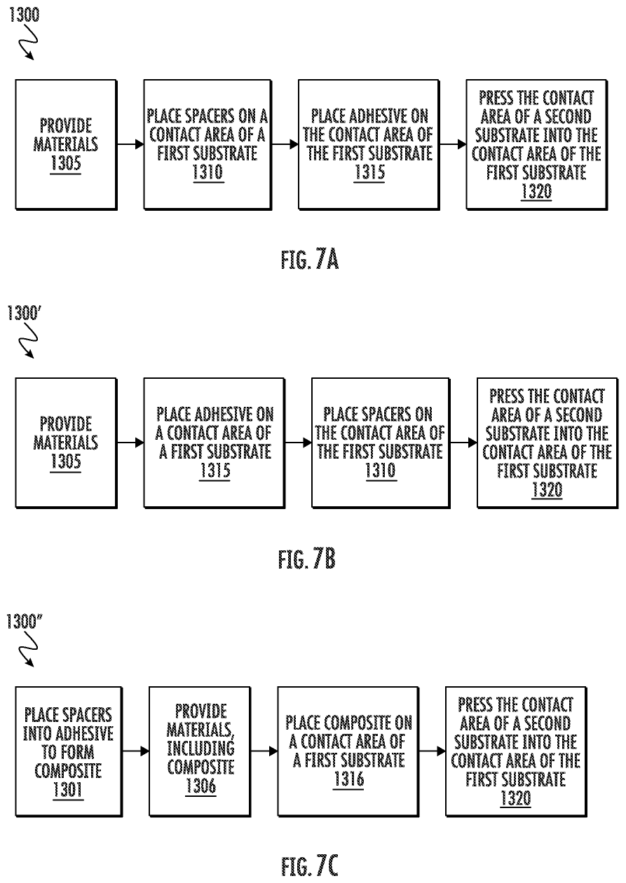

Dependent on waveguide refractive index, one may need an even lower or higher refractive index than PMMA. Polylactic acid (PLA) has a refraction index of approximately 1.45, and this material may be used in spacers. As noted above, it may be desirable at times to use an adhesive and spacers having a similar refractive index. Doing so may be appropriate where spacers are provided proximate to (e.g., over) waveguides of one of the substrates, as illustrated in FIG. 6B (which is described in greater detail below). However, it may be unnecessary to use a similar refractive index of the spacers and the adhesive where no spacers are provided proximate to (e.g., over) waveguides of one of the substrates, as illustrated in FIG. 6A (which is described in greater detail below)—although spacers may still be provided in other contact areas to control the gap spacing.

FIGS. 6A-6B are schematic views of a waveguide assembly where a second substrate 1160 is illustrated at a distance away from the first substrate 1150, in accordance with some embodiments discussed herein. As illustrated, the two substrates may comprise fiducials 1108 at various locations, and these fiducials may be used to align the first substrate 1150 and the second substrate 1160 together. Furthermore, the first substrate 1150 may comprise one or more waveguides 1152, and the second substrate 1160 may comprise one or more waveguides 1162. Adhesive 1174 may be applied at various surfaces (e.g., contact areas) on the first substrate 1150. This adhesive may be placed proximate to (e.g., over) the waveguides 1152, and the adhesive may be placed at other locations (e.g., contact areas) away from the waveguides 1152. One or more spacers 1172 may also be provided. In the embodiment shown in FIG. 6A, no spacers are provided proximate (e.g., over) the waveguides 1152. However, one or more spacers 1172 are provided at other locations on the first substrate 1150 away from the waveguides 1152. Once the adhesive 1174 and the spacers 1172 are positioned as desired, the second substrate 1160 may be urged toward the first substrate 1150 so that the desired gap spacing may be accomplished.

FIG. 6B is similar to FIG. 6A. However, in FIG. 6B, one or more spacers 1172 are provided at (e.g., over) the waveguides 1152 of the first substrate 1150. Where spacers 1172 are provided at the waveguides 1152, it may be important to use spacers with an appropriate refractive index to ensure optimal coupling between the waveguides 1152 and the waveguides 1162.

In both of the illustrated embodiments of FIGS. 6A and 6B, the use of waveguides may allow for an effective and cost-efficient approach for controlling the gap spacing between two substrates, and this may optimize evanescent coupling between the waveguides in the two substrates.

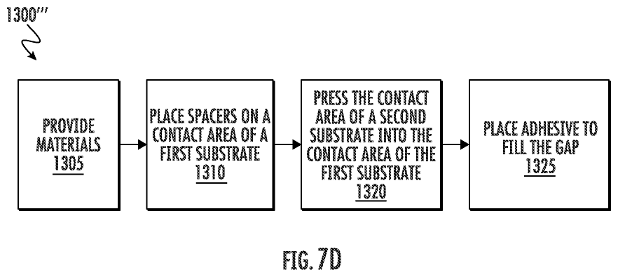

Spacers and adhesive may be introduced onto a substrate and secured between two substrates in a variety of ways. FIG. 7A-7D are flow charts illustrating various example methods 1300, 1300′, 1300″, and 1300′″ of implementing spacers and adhesive onto a substrate to accomplish a desired gap spacing.

In FIG. 7A, the materials are provided at operation 1305. These materials may comprise one or more spacers, an adhesive, a first substrate having a first waveguide, and a second substrate having a second waveguide. The height for the one or more spacers may be less than 10 μm in some embodiments. In some embodiments, the height for the one or more spacers may range from 500 nm to 2 μm.

At operation 1310, the spacers are placed on a contact area of a first substrate. At operation 1315, the adhesive is then placed on the contact area of the first substrate. The contact area of the first substrate may be an area on the surface of the first substrate that is configured to receive and contact the adhesive and the one or more spacers. In some embodiments, this contact area will not include an area proximate to any waveguides for the first substrate. However, in other embodiments, this contact area may include an area proximate to (e.g., over) the waveguides for the first substrate. The contact area for the first substrate and the second substrate may be substantially flat and free of any recesses. In this way, spacers that are spherical may be allowed to roll to positions in the gap having a slightly greater gap width.

At operation 1320, the contact area of the second substrate is pressed into the contact area of the first substrate. Similar to the contact area of the first substrate, the contact area of the second substrate may be an area on the surface of the second substrate that is configured to contact the adhesive and the one or more spacers. The two substrates may be pressed together until the desired gap spacing is accomplished. In performing operation 1320, some adhesive may tend to shift outside of the gap between the first substrate and the second substrate as a force is applied. This excess adhesive may be removed.

This method may provide a cost-efficient approach for controlling the gap spacing between waveguides of two substrates, permitting optimal evanescent coupling to be accomplished. While the spacers and adhesives are first added to the first substrate in the described embodiment, they may instead be initially added to the second substrate instead. Further, in some embodiments, adhesive and/or spacers may be added to the first substrate and the second substrate before the two substrates are pressed together. The one or more spacers may be placed on the first substrate and then adhesive may be applied onto the first substrate around the one or more spacers in some cases. In some embodiments, the one or more spacers may be placed on the first substrate and the adhesive may be applied onto the second substrate prior to bringing the substrates together.

FIG. 7B is a flow chart illustrating an example method 1300′. Method 1300′ is a variation of the method 1300 shown in FIG. 7A. In this embodiment, operation 1315 occurs before operation 1310. Thus, adhesives are added to the contact area of the first substrate before spacers are added to the same location. This figure shows that the operations of methods described herein may be rearranged into various orders without departing from the scope of the invention. As a further example, while operation 1305 indicates that materials are provided initially, materials may be provided as they are needed at subsequent operations. Additionally, methods may be modified by adding further operations or by removing operations.

FIG. 7C is a flow chart illustrating another example method 1300″, in accordance with some embodiments discussed herein. Method 1300″ is another variation of method 1300. In this variation, operation 1301 is performed. At operation 1301, spacers are placed into the adhesive to form a composite material. This composite material may be formed before the adhesive and the spacers ever come into contact with either the first substrate or the second substrate.

At operation 1306, materials may be provided, and these materials include the composite material created at operation 1301. Materials may also comprise a first substrate having a first waveguide and a second substrate having a second waveguide.

At operation 1316, the composite material is placed on the contact area of the first substrate. At operation 1320, the contact area of the second substrate may be pressed into the contact area of the first substrate.

FIG. 7D is a flow chart illustrating an example method 1300′″. Method 1300′″ is a variation of the method 1300 shown in FIG. 7A. In this embodiment, operation 1315 does not occur and, instead, operation 1320 is performed before adhesive is placed into the gap. To explain, once the spacers are placed on the contact area of the first substrate (operation 1310), the second substrate is pressed onto the spacers on the first substrate (operation 1320) and the gap is formed therebetween. Thereafter, at operation 1325, the adhesive is placed proximate the gap and capillary force causes the adhesive to fill in the gap, such as around the spacers. In some embodiments, the adhesive may be placed directly into the gap.

FIGS. 7A-7B and 7D illustrate approaches where spacers and the adhesive are separate from each other until positioned on the first substrate. By contrast, FIG. 7C illustrates an approach where the spacers and the adhesive are combined together to form combined adhesive and spacers before the combined adhesive and spacers are positioned on the first substrate.

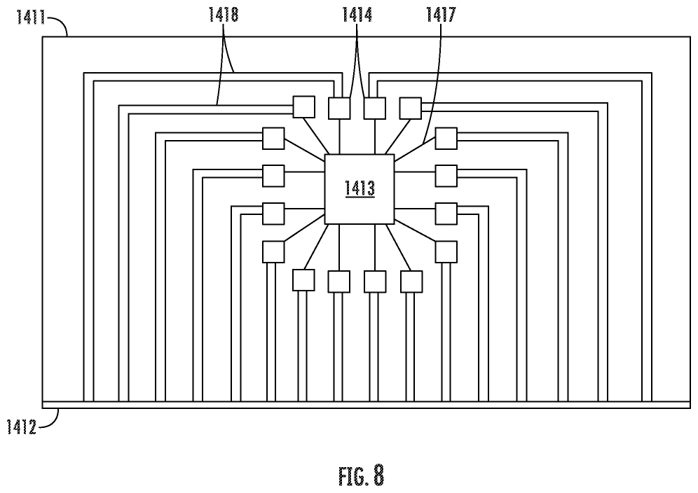

FIG. 8 illustrates an optical printed circuit board (PCB) 1411. The waveguide assembly described in various embodiments herein may be used in an optical PCB similar to the optical PCB 1411 of FIG. 8. The illustrated optical PCB 1411 is connected to a front plate 1412. Waveguide groups 1418 may comprise one or more surface or subsurface waveguides (e.g. 302 in FIG. 3), and these waveguide groups 1418 may extend to the edge of the optical PCB 1411 where the front plate 1412 is positioned. The waveguide groups 1418 may also extend to a peripheral interface controller (PIC) 1414. The PICs 1414 may be connected by electrical lines 1417 to an application-specific integrated controller (ASIC) 1413. Optical-electrical substrates (e.g. 350 and 360 in FIGS. 2 and 3) may be secured at or near a PIC 1414 so that glass-to-glass or glass-to-silicon evanescent waveguide coupling may occur. However, other types of coupling may occur in other embodiments.

Spacers used as described above may be provided through a variety of approaches, and the spacers may have a variety of compositions. In one example approach, microsphere spacers having polylactic acid (PLA) and polyvinyl alcohol (PVA) in the 1-2 μm range may be made by an emulsion process. Various techniques may be taken for making spacers such as solvent evaporations and a microfluidic droplet technique. To prepare spacers, an example approach is set forth in the article “Control of shape and size of poly (lactic acid) microspheres based on surfactant and polymer concentration” by Barkha Singh et al. Organic PLA solution in dichloromethane (DCM) and aqueous phase PVA solution in purified water may be provided. These solutions may be prepared using a stirrer, which may be a magnetic stirrer. The solutions may be placed in test tubes containing polymer solution and may be emulsified with a vortex mixer. The solutions may then be emulsified with a homogenizer. Centrifugation-washing of spacers may then occur. Then, dispersion of spacers may be completed in purified water, and the spacers may be stored in cold temperature at 4 degrees Celsius. Then, the spacers may be characterized using field emission scanning electron microscopy (FESEM), Fourier-transform infrared spectroscopy (FT-IR), and zeta potential. Further information about this method of preparing spacers may be found in Singh et al, which is incorporated by reference herein in its entirety.

The approach set forth in Singh et al. is one approach for forming spacers, but other approaches may be used as well such as a solvent evaporation approach and a microfluidic droplet technique. A droplet-on-demand (DOD) T-junction microfluidic emulsions technique is an intriguing approach because it has the possibility of making very uniform monodisperse spacers of a wide range of polymer compositions.

To form spacers using an emulsion approach, one may inject the desired adhesive into one channel while drawing it as an emulsion with inert oil. The droplets of the size controlled emulsion may then be UV irradiated to polymerize the adhesive and form solid microspheres of the target adhesive. Then, one may follow up with a thermal cure and particle size characterization. Controlling the rate of draw between the oil and adhesive and dimensions of the microfluidic channel may be optimized to yield correct size spacer microspheres.

It will therefore be readily understood by those persons skilled in the art that the present disclosure is susceptible of broad utility and application. Many embodiments and adaptations of the present disclosure other than those herein described, as well as many variations, modifications and equivalent arrangements, will be apparent from or reasonably suggested by the present disclosure and the foregoing description thereof, without departing from the substance or scope of the present invention. Accordingly, while the present disclosure has been described herein in detail in relation to its preferred embodiment, it is to be understood that this disclosure is only illustrative and exemplary of the present disclosure and is made merely for purposes of providing a full and enabling disclosure of the disclosure. The foregoing disclosure is not intended to be construed to limit the present invention or otherwise to exclude any such other embodiments, adaptations, variations, modifications and equivalent arrangements.

What is claimed is:

1. A waveguide assembly, the waveguide assembly comprising:
a first substrate comprising a first waveguide;
a second substrate comprising a second waveguide;
an adhesive; and
one or more spacers, wherein a height for the one or more spacers is less than 10 microns, wherein the adhesive and the one or more spacers provide a composite material configured to assist in securing the first substrate and the second substrate together to align the first waveguide and the second waveguide, wherein, when the first substrate and the second substrate are attached together via the adhesive, the one or more spacers are configured to maintain a desired gap spacing between the first substrate and the second substrate so as to optimize coupling efficiency between the first waveguide and the second waveguide, wherein the desired gap spacing corresponds to the height for the one or more spacers.

2. The waveguide assembly of claim 1, wherein the first substrate and the second substrate are parallel with each other, and wherein the first substrate comprises a first contact area and the second substrate comprises a second contact area, wherein the first contact area of the first substrate and the second contact area of the second substrate are configured to receive and contact the adhesive and the one or more spacers.

3. The waveguide assembly of claim 2, wherein the first contact area of the first substrate and the second contact area of the second substrate are flat and free of any recesses.

4. The waveguide assembly of claim 2, wherein the first substrate and the second substrate are configured to receive the adhesive without any spacers at the first waveguide and the second waveguide respectively.

5. The waveguide assembly of claim 1, wherein the first substrate and the second substrate are configured to receive the adhesive and spacers at the first waveguide and the second waveguide respectively.

6. The waveguide assembly of claim 1, wherein each of the one or more spacers define a spherical shape.

7. The waveguide assembly of claim 1, wherein the height for the one or more spacers is between about 100 nanometers and about 4 microns.

8. The waveguide assembly of claim 1, wherein the height for the one or more spacers is between about 300 nanometers and about 3 microns.

9. The waveguide assembly of claim 1, wherein the height for the one or more spacers is between about 500 nanometers and about 2 microns.

10. The waveguide assembly of claim 1, wherein the one or more spacers and the adhesive are separate from each other until positioned on the first substrate.

11. The waveguide assembly of claim 1, wherein the one or more spacers and the adhesive are combined together to form combined adhesive and spacers before the combined adhesive and spacers are positioned on the first substrate.

12. The waveguide assembly of claim 1, wherein the waveguide assembly is formed by a process comprising placing the one or more spacers on the first substrate and then applying the adhesive onto the first substrate around the one or more spacers.

13. The waveguide assembly of claim 1, wherein the waveguide assembly is formed by a process comprising:
placing the one or more spacers on the first substrate;
pressing the second substrate against the one or more spacers applied to the first substrate to form a gap therebetween; and
applying the adhesive proximate the gap to enable flow of the adhesive into the gap.

14. The waveguide assembly of claim 1, wherein the waveguide assembly is formed by a process comprising:
inserting the one or more spacers into the adhesive to form combined adhesive and spacers;
applying the combined adhesive and spacers onto the first substrate; and
pressing the second substrate against the combined adhesive and spacers applied to the first substrate.

15. The waveguide assembly of claim 1, wherein a refractive index of the adhesive is within 0.1 of a refractive index of the one or more spacers.

16. The waveguide assembly of claim 1, wherein the adhesive and the one or more spacers comprise a same material.

17. The waveguide assembly of claim 1, wherein the desired gap spacing is selected to optimize the amount of evanescent coupling between the first waveguide and the second waveguide, wherein the desired gap spacing is determined based on at least one of a material for the first substrate, a material for the second substrate, a material for the first waveguide of the first substrate, a material for the second waveguide of the second substrate, an overlap length between the first substrate and the second substrate, an overlap width between the first substrate and the second substrate, or an overlap area between the first substrate and the second substrate.

18. A composite material for use with waveguides, the composite material comprising:
an adhesive; and
one or more spacers, wherein a height for the one or more spacers is less than 10 microns, wherein the adhesive and the one or more spacers provide the composite material configured to assist in securing a first substrate and a second substrate together, wherein the one or more spacers are configured to maintain a desired gap spacing between two substrates so as to optimize coupling efficiency between the first waveguide and the second waveguide, wherein the desired gap spacing corresponds to the height for the one or more spacers.

19. The composite material of claim 18, wherein the composite material is made by placing the one or more spacers on a first substrate and by then inserting the adhesive on the first substrate between the one or more spacers.

20. The composite material of claim 18, wherein the composite material is made by inserting the one or more spacers into the adhesive, wherein the composite material is formed before placing the one or more spacers on a first substrate.

21. A method for forming a waveguide assembly comprising:
providing a first substrate having a first waveguide, a second substrate having a second waveguide, an adhesive, and one or more spacers;
placing the one or more spacers on a first contact area of the first substrate, wherein a height for the one of the one or more spacers is less than 10 microns;
placing the adhesive on the first contact area of the first substrate; and
pressing a second contact area of the second substrate into the first contact area of the first substrate until a desired gap spacing is obtained,
wherein the desired gap spacing is obtained so as to optimize coupling efficiency between the first waveguide and the second waveguide, wherein the desired gap spacing corresponds to the height of the one or more spacers.

22. The method of claim 21, wherein placing the one or more spacers on the first contact area of the first substrate occurs before placing the adhesive on the first contact area of the first substrate.

23. The method of claim 21, wherein placing the one or more spacers on the first contact area of the first substrate occurs after placing the adhesive on the first contact area of the first substrate.

24. A method for forming a waveguide assembly comprising:
providing a first substrate having a first waveguide, a second substrate having a second waveguide, an adhesive, and one or more spacers;
inserting the one or more spacers into the adhesive to form a composite material;
placing the composite material on a first contact area of the first substrate; and
pressing a second contact area of the second substrate into the first contact area of the first substrate until a desired gap spacing is obtained,
wherein the desired gap spacing is obtained so as to optimize coupling efficiency between the first waveguide and the second waveguide, wherein the desired gap spacing corresponds to a height of the one or more spacers.

25. A waveguide assembly comprising:
a first substrate comprising a first waveguide;
a second substrate comprising a second waveguide; and
a composite material that is configured to assist in securing the first substrate and the second substrate together, the composite material comprising adhesive that includes one or more spacers mixed into an adhesive prior to application to the first substrate or second substrate, wherein the one or more spacers are configured to maintain a desired gap spacing between the first substrate and the second substrate so as to optimize coupling efficiency between the first waveguide and the second waveguide, and wherein the desired gap spacing corresponds to a height of the one or more spacers.
